(19) United States
(12) Patent Application Publication
(10) Pub. No.: US 2009/0229083 A1
(43) Pub. Date: Sep. 17, 2009

(54) Headset Clip System

(75) Inventor: Frederick P. DeKalb, Ben Lomond, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/046,384

(22) Filed: Mar. 11, 2008

(51) Int. Cl. A44B 21/00; H01R 13/02

(52) U.S. Cl. 24/3.12; 439/890

(57) ABSTRACT

A headset clip assembly which includes a clip for attaching to a cloth material and a coupling mechanism for mating with a headset interface to couple the clip assembly to a headset.

### BACKGROUND OF THE INVENTION

Wireless mobile headsets offer users convenient and discrete telecommunications. However, when not in use, storage of the headsets in a secure but convenient to access manner is problematic. Currently, most users simply place the headset in their purse or pocket. However, in this location the headset is difficult to quickly access. In addition, the headset may be scratched or damaged.

As a result, there is a need for improved methods and apparatuses for headset storage during non-use.

### BRIEF DESCRIPTION OF THE DRAWINGS

The present invention will be readily understood by the following detailed description in conjunction with the accompanying drawings, wherein like reference numerals designate like structural elements.

FIG. 1 illustrates an embodiment of a headset clip system of the present invention in a decoupled state.

FIG. 2 illustrates an embodiment of a headset clip system of the present invention in a coupled state.

FIG. 3A illustrates a perspective view of the clip assembly shown in FIG. 1 in one example of the invention.

FIG. 3B illustrates a top view of the clip assembly shown in FIG. 1 in one example of the invention.

FIG. 3C illustrates a side view of the clip assembly shown in FIG. 1 in one example of the invention.

FIG. 3D illustrates an end view of the clip assembly shown in FIG. 1 in one example of the invention.

FIG. 4 illustrates an embodiment of the headset interface of the present invention shown in FIG. 1.

FIG. 5 illustrates the backside of the headset shown in FIG. 4 in one example.

FIG. 6 illustrates coupling of the clip assembly to the headset interface.

FIG. 7 illustrates a further embodiment of a headset clip system of the present invention in a decoupled state.

FIG. 8 illustrates a further embodiment of a headset clip system of the present invention in a coupled state.

FIG. 9A illustrates a perspective view of the clip assembly shown in FIG. 8 in one example of the invention.

FIG. 9B illustrates a top view of the clip assembly shown in FIG. 8 in one example of the invention.

FIG. 9C illustrates a side view of the clip assembly shown in FIG. 8 in one example of the invention.

FIG. 9D illustrates a bottom view of the clip assembly shown in FIG. 8 in one example of the invention.

FIG. 10 illustrates an example of a headset clip system in a decoupled state

FIGS. 11A-11D illustrate a perspective view, top view, side view, and end view, respectively, of the clip assembly shown in FIG. 10.

FIGS. 12 and 13 illustrate a further example of a headset clip system in a decoupled state and coupled state, respectively.

FIGS. 14A-14D illustrate a perspective view, top view, side view, and bottom view, respectively, of the clip assembly shown in FIG. 12.

FIG. 15 illustrates a further example of a headset clip system in a decoupled state.

### DESCRIPTION OF SPECIFIC EMBODIMENTS

Methods and apparatuses for headset storage or transport are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

The invention relates to the general field of headsets and specifically to storage or transport of headsets when not in use. This description describes a method and apparatus for headset with a headset interface which may be coupled to a clothing clip assembly. This invention allows a headset to be attached almost anywhere on the user's clothing for easy access when an incoming call is received. In one example, the headset interface serves a dual purpose as a charging interface and a clothing clip interface.

In one example, a headset clip system includes a clip assembly and a headset interface. The clip assembly includes a biting pair of spring loaded teeth, and a cylindrical plug including an interior receptacle and an exterior surface having a groove. The headset interface includes a housing with a front surface, where the front surface includes an aperture leading to a housing well. A spring coil is disposed within the housing well for positioning against the groove and a pin is disposed within the housing well for inserting into the interior receptacle. The clip assembly is in a coupled state with the headset interface when the pin is inserted in the interior receptacle and the spring coil is in physical contact with the groove.

In one example, a headset clip system includes a clip assembly and a headset interface. The clip assembly includes a gripping mechanism for removably attaching to a cloth material, and a cylindrical plug comprising an interior receptacle and an exterior having a groove. The headset interface includes a housing with a front surface, where the front surface includes an aperture leading to a housing well. A spring coil is disposed within the housing well for positioning against the groove and a pin is disposed within the housing well for inserting into the interior receptacle. The clip assembly is in a coupled state with the headset interface when the pin is inserted in the interior receptacle and the spring coil is in physical contact with the groove.

In one example, a headset clip system includes a clip assembly and a headset interface. The clip assembly includes a clip capable of gripping a cloth material, and a cylindrical plug with an interior receptacle and an exterior having a groove. The headset interface includes a housing with a front surface, where the front surface includes an aperture leading to a housing well. A spring coil is disposed within the housing well for positioning against the groove and a pin is disposed within the housing well for inserting into the interior receptacle. The clip assembly is in a coupled state with the headset interface when the pin is inserted in the interior receptacle and the spring coil is in physical contact with the groove.

In one example, a headset clip system includes a clip assembly and a headset interface. The clip assembly includes a cylindrical plug having a first end, a second end, and an exterior having a groove, where the first end includes an interior receptacle. The clip assembly includes a post portion with a third end attached to the second end and a fourth end having a pointed portion capable of piercing a cloth material. The clip assembly further includes a clasp for receiving the pointed portion and releasably attaching to the post portion. The headset interface includes a housing with a front surface, where the front surface includes an aperture leading to a housing well. A spring coil is disposed within the housing well for positioning against the groove and a pin is disposed within the housing well for inserting into the interior receptacle. The clip assembly is in a coupled state with the headset interface when the pin is inserted in the interior receptacle and the spring coil is in physical contact with the groove.

In one example, a headset clip system includes a headset and a clip assembly. The headset includes a headset interface utilizing a first coupling mechanism. The clip assembly includes a clip device capable of gripping a cloth material, and a second coupling mechanism capable of removably coupling to the first coupling mechanism. In one example, the first coupling mechanism is a charging interface capable of receiving charging power when coupled to a power source. In a further example, the first coupling mechanism is a micro USB AB type receptacle (female) connector and the second coupling mechanism comprises a micro A or micro B connector plug. In yet another example, the first coupling mechanism is a magnet and the second coupling mechanism is a second magnet. In one example, the clip device is a pair of clipping portions and a spring. In a further example, the clip device is a clasp removably attachable to a post.

In one example, a headset clip assembly includes a clip device capable of gripping a cloth material, and a coupling mechanism capable of removably coupling to a headset interface. In one example, the headset interface is a charging interface capable of receiving charging power when coupled to a power source. In one example, the coupling mechanism is a micro A or micro B connector plug. In a further example, the coupling mechanism comprises a magnet. In one example, the clip device is a pair of clipping portions and a spring. In a further example, the clip device is a clasp removably attachable to a post.

In one example, a headset clip assembly includes an affixing means, such as an alligator clip or shirt pin mechanism, for attaching to a cloth material. The headset clip assembly further includes a coupling means, such as a cylindrical plug or micro A or micro B connector plug, for removably coupling to a headset interface. The coupling means is attached to the affixing means.

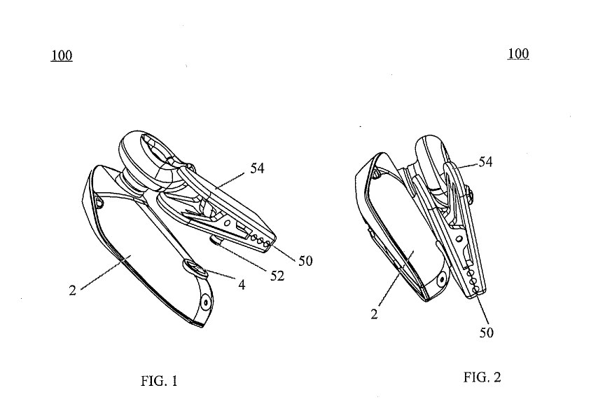

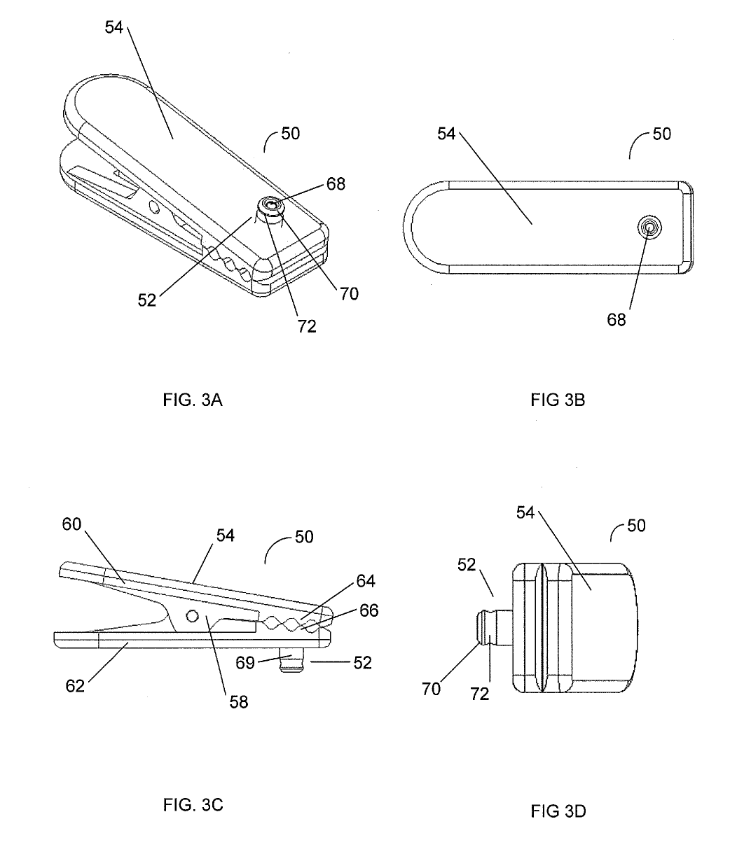

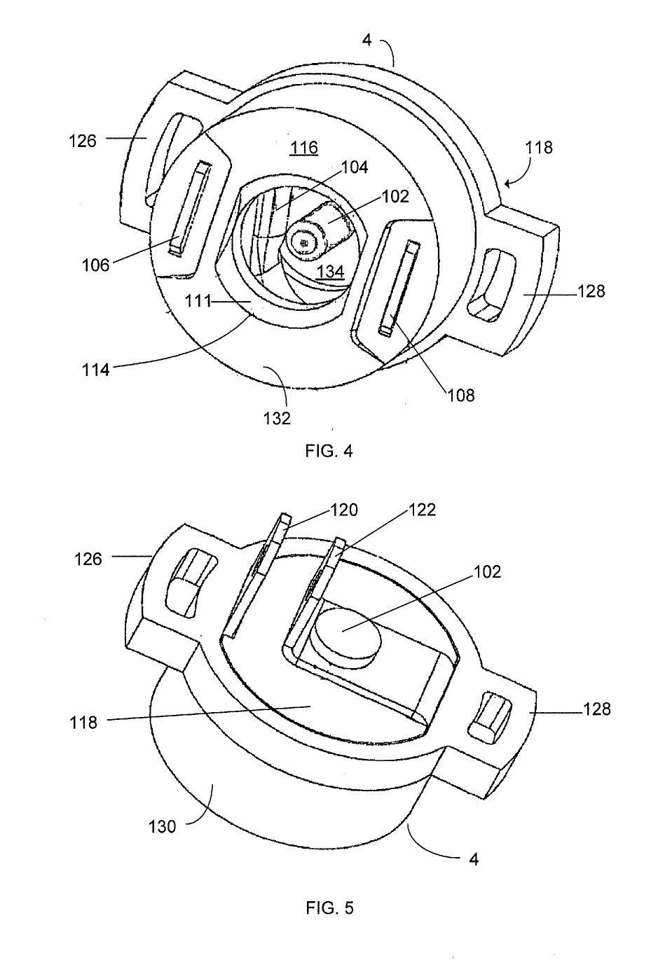

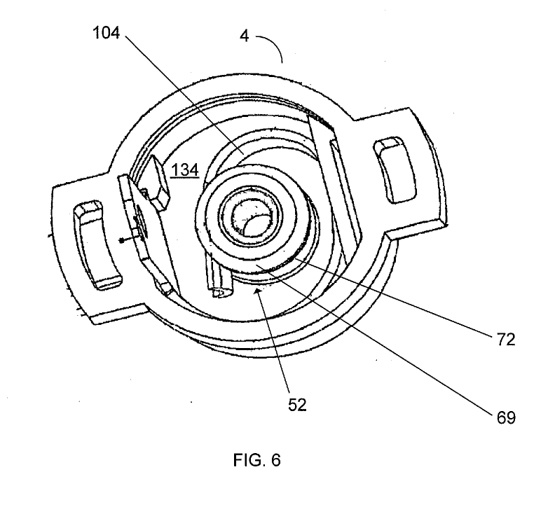

Referring to FIGS. 1 and 2, an embodiment of a headset clip system 100 of the present invention in a decoupled state and coupled state, respectively, is illustrated. The headset clip system 100 includes a clip assembly 50 and a headset 2 having a headset interface 4. The clip assembly 50 includes an “alligator” style clip 54 having a biting pair of spring loaded teeth, and a cylindrical plug 52. Cylindrical plug 52 is described in further detail with reference to FIGS. 3A-3D. Headset interface 4 is described in further detail with reference to FIG. 4 and FIG. 5. Referring to FIG. 2, the headset clip system 100 is shown in a coupled state where cylindrical plug 52 has been inserted into headset interface 4. In this coupled state, clip assembly 50 is used to attach headset 2 to a user's clothing with the spring loaded teeth.

FIGS. 3A-3D illustrate a perspective view, top view, side view, and end view, respectively, of the clip assembly 50 shown in FIG. 1 in one example of the invention. Alligator clip 54 consists essentially of a spring 58, and a pair of clipping portions 60, 62. Clipping portions 60, 62 have spring loaded teeth 64, 66 respectively. In a further example, clipping portions 60, 62 do not have teeth. In operation, the spring loaded teeth 64, 66 clamp to the wearer's clothing such as a pocket flap thereby securing the headset for transport while not in use and maintaining easy accessibility when use is desired. Cylindrical plug 52 includes an interior receptacle 68 and an exterior surface 69 having a flanged surface 70 and groove 72. Interior receptacle 68 is designed to receive and mate with a headset interface 4 component as described below in reference to FIG. 4.

FIG. 4 illustrates an embodiment of the headset interface 4 of the present invention shown in FIG. 1. The headset interface 4 is referred to by the inventor as a Standard Mechanical Interface (SMIF) charge connector, which in one example has a dual use both as a charging interface and as a snap to a clothing clip assembly.

The headset interface 4 includes an outer housing 132 with a front surface 116 and a back surface 118, where the front surface includes an aperture 114 leading to a housing well 134 for accepting a male plug. Outer housing 132 is made of a molded polymer, although any suitable material may be used. When integrated with a headset, the front surface of the headset interface 4 is exposed on the headset surface as shown in FIG. 1. A spiral coil 104 is disposed within the housing well 134 and a pin structure 102 is disposed within the housing well 134. Spiral coil 104 operates as a spring coil capable of extending in a radial direction when a force is applied and automatically retracting when the force is released. The clip assembly 50 is in a coupled state with the headset interface 4 when the pin structure 102 is inserted in the interior receptacle 68 and the spiral coil 104 is in physical contact mated with the groove 72.

In operation, the cylindrical plug 52 is inserted through aperture 114 into well 134. During insertion of cylindrical plug 52, spiral coil 104 of headset interface 4 extends in an outward radial direction due to force from cylindrical plug exterior surface 69. Simultaneously, pin structure 102 of headset interface 4 fits into the cylindrical plug interior receptacle 68. As the insertion process of cylindrical plug 52 continues, the force on spiral coil 104 by exterior surface 69 recedes as the flanged surface 70 becomes parallel with spiral coil 104, resulting in spiral coil 104 retracting into groove 72 of exterior surface 69 in a detent position.

Simultaneously, pin structure 102 continues to be inserted into interior receptacle 68 until full insertion is reached, corresponding to the coupled detent position. In this manner, the clip assembly 50 is secured to the headset 2. Referring to FIG. 6, spiral coil 104 of headset interface 4 is shown mated in a detent position with groove 72 of exterior surface 69 after insertion of cylindrical plug 52 into well 134. For clarity, headset interface pin structure 102 is not shown in FIG. 6. In one example, cylindrical plug 52 is composed of a non-electrically conductive material, such as a molded polymer, although any suitable material may be used.

In one example, headset interface 4 serves as both a charging interface to receive charging power for the headset battery and as an interface to attach a clip assembly 50. In this example, where headset interface 4 serves both purposes, headset interface 4 includes two charging interfaces. Referring again to FIG. 4, the first charging interface utilizes stationary charging contacts comprising negative contact arc 106 and positive contact arc 108 disposed on front surface 116. Negative contact arc 106 and positive contact arc 108 mate with corresponding contacts on a charging base when the headset is inserted into the charging base. The corresponding contacts on the charging base are typically spring loaded, and engage negative contact arc 106 and positive contact arc 108 when the headset is inserted into the charging base. Negative contact arc 106 is coupled to electrical ground.

In an embodiment of the invention, the first charging interface further utilizes a semi-spherical recessed area 111 and aperture 114 to secure contact between negative contact arc 106 and positive contact arc 108 with corresponding charging contacts on a charging base. In one example, the aperture 114 receives a charging member to detent the second positive contact and the second negative contact with corresponding contacts on a charger. Charging bases, charging cables, and associated charging members are discussed further in U.S. Pat. No. 6,923,688 assigned to Plantronics, Inc., which is hereby incorporated by reference for all purposes.

The second charging interface comprises a negative contact and positive contact disposed within well 134 behind aperture 114. Spiral coil 104 positioned within well 134 serves as the negative contact and pin structure 102 disposed in the center of well 134 serves as the positive contact.

A male charging plug is used to mate with spiral coil 104 and pin structure 102 to transfer charging current to the headset battery. The male charging plug is substantially similar to the cylindrical plug 52 described earlier. However, in this example, the charging plug interior receptacle 68 is an electrically conductive contact and the exterior surface 69 is an electrically conductive contact made of a suitable material, such as copper.

Each set of the headset interface charging contacts can be used independently from the other set to transfer charging current. When the headset is coupled to a charger, one of the sets of charging contacts electrically couple to contacts of the charger, and charging current is supplied from the charger to the battery at the headset to recharge the battery. Dual contact systems disposed on a single headset are beneficial in that they allow a user a choice of charging systems depending on the user's location. For example a cable adaptable for use with a cigarette lighter may be used in an automobile environment, while a charging base may be preferred at the user's office location. In the present example, the headset interface serves the dual purpose of a dual charging contact system and a clothing clip interface, thereby maximizing available space on the headset housing.

Although referred to with different designations herein, in one example, negative contact spiral coil 104 and negative contact arc 106 are a single piece construction and electrically parallel. Similarly, positive contact 108 and positive contact pin structure 102 are a single piece construction and electrically parallel. In this dual use charging interface example, the negative contact spiral coil 104 and the positive contact pin structure 102 are made of a suitable electrically conductive material such as copper.

The headset interface 4 utilizes aperture 114 in both the first charging interface and the second charging interface. By utilizing the aperture 114 in both charging interfaces, the area required by the headset interface 4 is minimized.

In one example, the headset interface 4 is mounted from inside the headset housing and presents an approximately 6.5 mm diameter plastic face with slightly raised metal negative contact arc 106 and positive contact arc 108 arrayed around aperture 114. For appearance purposes, the module is mounted so that the face is as flush as possible to the surface of the headset housing. The contact arcs are proud of the surface by about 0.1 mm to 0.2 mm in one example. The contact arcs may either be are concentric or linearly shaped.

Referring to FIG. 5 showing the backside of outer housing 132 is shown. The bottom surface of pin structure 102 is shown. Outer housing 132 includes a back surface 118. A negative terminal 120 and positive terminal 122 are utilized to provide charging current to a rechargeable battery located at the headset. In an embodiment of the invention, spiral coil 104, negative contact arc 106, and negative terminal 120 are a single piece construction. Similarly, pin structure 102, positive contact arc 108, and positive terminal 122 are a single piece construction.

The headset battery is a rechargeable battery, such as a lithium ion battery, which is electrically coupled to negative terminal 120 and positive terminal 122. The electrically parallel first charging interface and second charging interface provide an efficient and space saving arrangement to provide charging power to the rechargeable battery. In an alternate embodiment, although electrically coupled, spiral coil 104, negative contact arc 106, and negative terminal 120 are not a single piece construction. Similarly, in an alternate embodiment, pin structure 102, positive contact arc 108, and positive terminal 122 are not a single piece construction. Pin structure 102 extends through positive terminal 122 and back surface 118 into well 134. Outer housing 132 further includes headset mounting handles 126 and 128 for mounting headset interface 4 within a headset. Charging current is provided to a battery at the headset coupled to negative terminal 120 and positive terminal 122 regardless of which charging interface is utilized.

Furthermore, the headset interface 4 is designed for use with common preexisting systems for providing charging power such as spring loaded contact mechanisms while also providing for use with charging power systems with advanced mechanisms to protect the headset surface during coupling of the headset and charger. Thus, a headset charging interface can be implemented in the headset that can accommodate different charger system configurations in a space saving, compact, mass produced, and low cost headset.

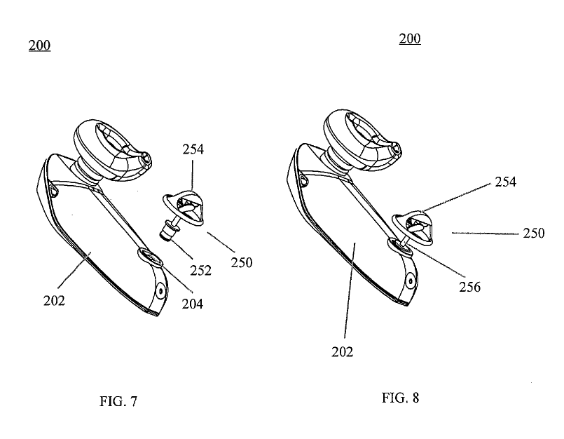

Referring to FIGS. 7 and 8, an embodiment of a headset clip system 200 of the present invention in a decoupled state and coupled state, respectively, is illustrated. The headset clip system 200 includes a clip assembly 250 and a headset 202 having a headset interface 204. The clip assembly 250 includes a clasp 254, and a cylindrical plug 252 having a post 256 attached to which clasp 254 attaches. Cylindrical plug 252 is as described above in reference to cylindrical plug 52 in FIGS. 3A-3D. Headset interface 204 is described in further detail above with reference to FIG. 4 and FIG. 5. Referring to FIG. 8, the headset clip system 200 is shown in a coupled state where cylindrical plug 252 has been inserted into headset interface 204.

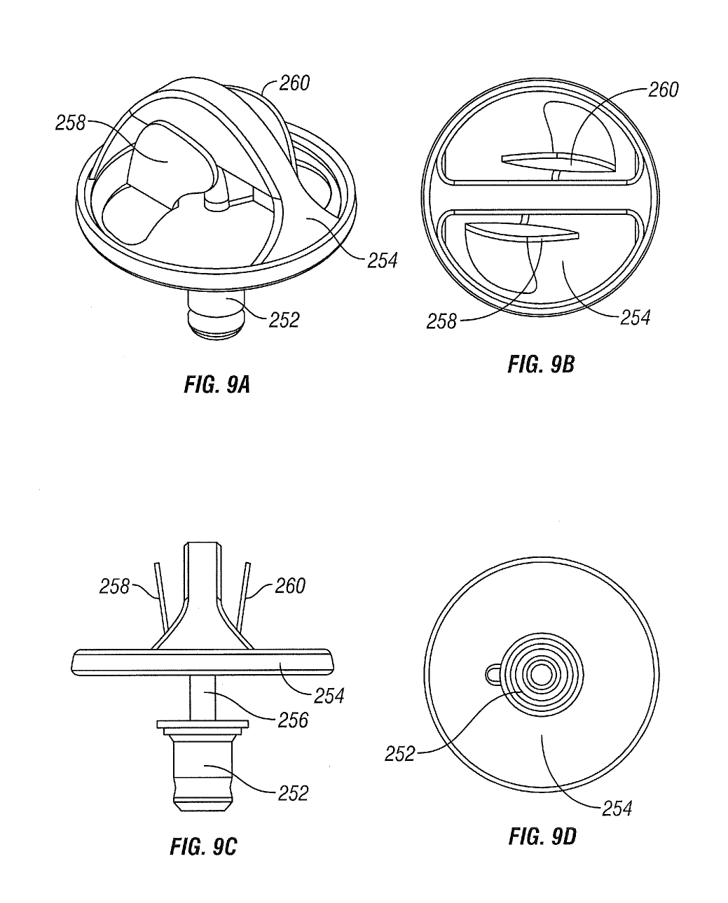

FIGS. 9A-9D illustrate a perspective view, top view, side view, and bottom view, respectively, of the clip assembly 250 shown in FIG. 7 in one example of the invention. Clip assembly 250 includes a clasp 254 and a cylindrical plug 252 having a post 256. One end of post 256 is attached to cylindrical plug 252 and the other end of post 256 terminates at a pointed portion capable of piercing a cloth material. For example, clasp 254 may be a “butterfly” clutch such as those used with lapel or shirt pins. Clasp 254 is configured to releasably lock onto post 256. Clasp 254 includes a pair of releases 258, 260 which are depressed to remove clasp 254 from post 256 or attach clasp 254 to post 256. In operation, a user attaches the clip assembly 250 to a headset by inserting cylindrical plug 252 into headset interface 204. The user removes clasp 254 from post 256 by pinching releases 258, 260 between the user's fingers and pulling the clasp 254 off of post 256. The exposed pointed end of post 256 is pushed through the desired area of clothing and the user affixes clasp 254 to post 256 by pinching releases 258, 260 between the user's fingers and placing a clasp hole over post 256 and releasing. The headset is thereby secured to the user's clothing for transport while not in use and maintains easy accessibility when use is desired.

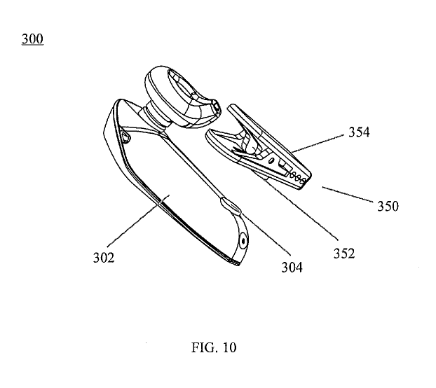

Referring to FIG. 10, an embodiment of a headset clip system 300 of the present invention in a decoupled state is illustrated. The headset clip system 300 includes a clip assembly 350 and a headset 302 having a headset coupling magnet 304. The clip assembly 350 includes an “alligator” style clip 354 having a biting pair of spring loaded teeth, and a coupling magnet 352. In a coupled state where headset coupling magnet 304 and coupling magnet 352 form a magnet bond, clip assembly 350 is used to attach headset 302 to a user's clothing with the spring loaded teeth.

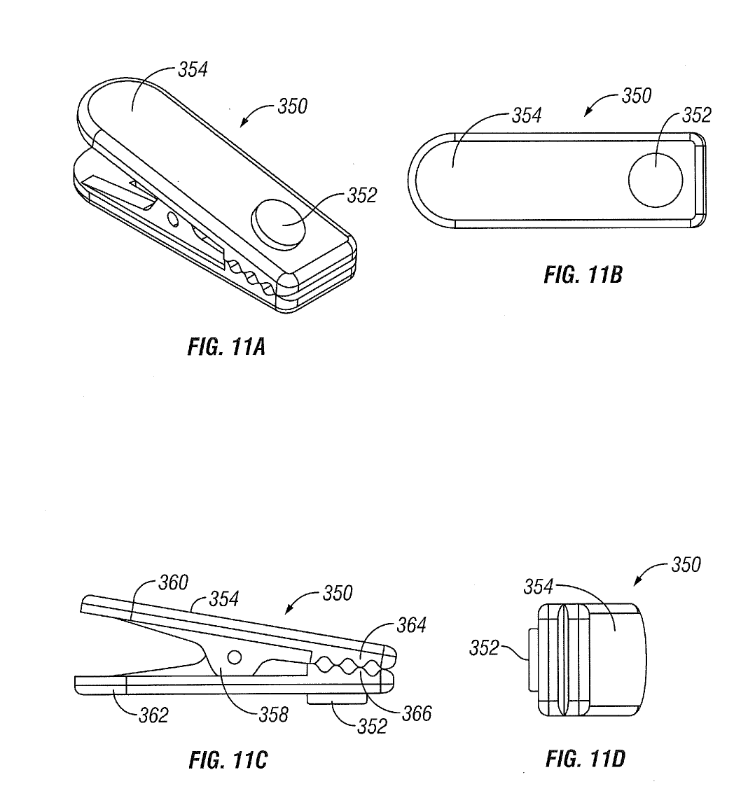

FIGS. 11A-11D illustrate a perspective view, top view, side view, and end view, respectively, of the clip assembly 350 shown in FIG. 10. Alligator clip 354 consists essentially of a spring 358, and a pair of clipping portions 360, 362. Clipping portions 360, 362 have spring loaded teeth 364, 366 respectively. In a further example, clipping portions 360, 362 do not have teeth. In operation, the spring loaded teeth 364, 366 clamp to the wearer's clothing such as a pocket flap thereby securing the headset for transport while not in use and maintaining easy accessibility when use is desired. Coupling magnet 352 and headset coupling magnet 304 may be any type of common magnet. In a further example, coupling magnet 352 is replaced with any magnetic metal capable of coupling with coupling magnet 304, or coupling magnetic 304 is replaced with any magnetic metal capable of coupling with coupling magnet 352. For example, steel may be used to replace either coupling magnet.

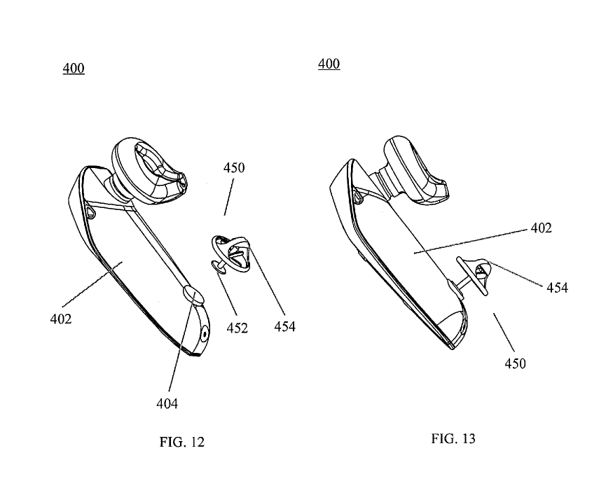

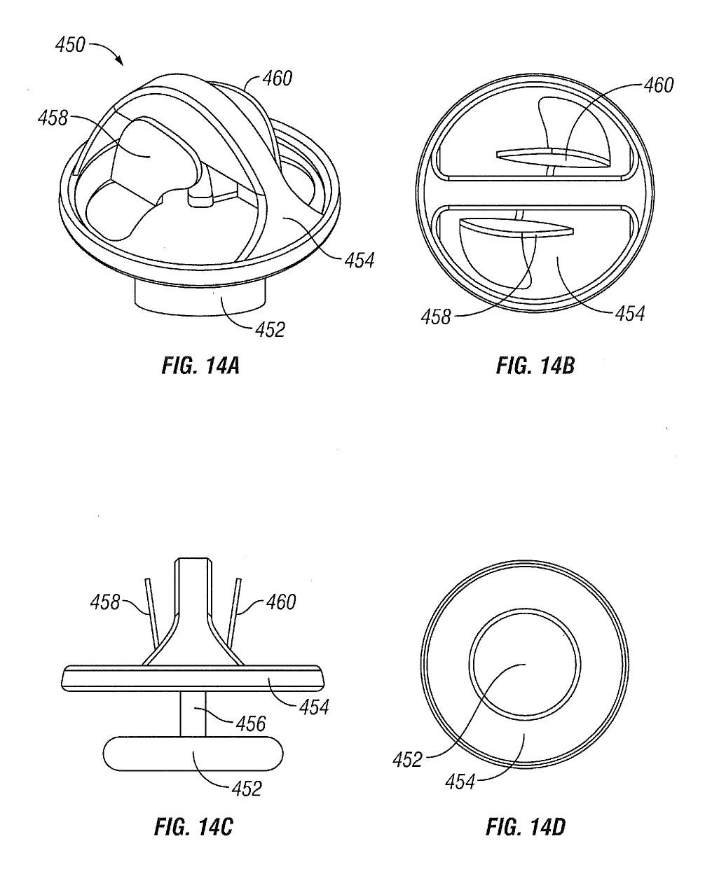

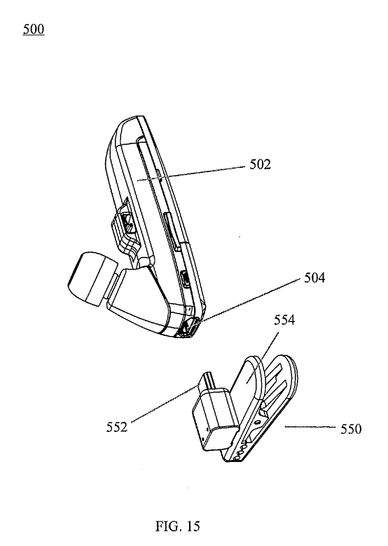

Referring to FIGS. 12 and 13, an embodiment of a headset clip system 400 of the present invention in a decoupled state and coupled state, respectively, is illustrated. The headset clip system 400 includes a clip assembly 450 and a headset 402 having a headset coupling magnet 404. The clip assembly 450 includes a clasp 454, and a coupling magnet 452 having a post 456 (shown in FIG. 14C) attached to which clasp 454 attaches. Referring to FIG. 13, the headset clip system 400 is shown in a coupled state where coupling magnet 452 has been mated with headset coupling magnet 404. In a further example, coupling magnet 452 is replaced with any magnetic metal capable of coupling with coupling magnet 404, or coupling magnetic 404 is replaced with any magnetic metal capable of coupling with coupling magnet 452.

FIGS. 14A-14D illustrate a perspective view, top view, side view, and bottom view, respectively, of the clip assembly 450 shown in FIG. 12. Clip assembly 450 includes a clasp 454 and a coupling magnet 452 having a post 456. One end of post 456 is attached to coupling magnet 452 and the other end of post 456 terminates at a pointed portion capable of piercing a cloth material. For example, clasp 454 may be a “butterfly” clutch such as those used with lapel or shirt pins. Clasp 454 is configured to releasably lock onto post 456. Clasp 454 includes a pair of releases 458, 460 which are depressed to remove clasp 454 from post 456 or attach clasp 454 to post 456. In operation, a user attaches the clip assembly 450 to a headset by contacting coupling magnet 452 to headset coupling magnet 404. The user removes clasp 454 from post 456 by pinching releases 458, 460 between the user's fingers and pulling the clasp 454 off of post 456. The exposed pointed end of post 456 is pushed through the desired area of clothing and the user affixes clasp 454 to post 456 by pinching releases 458, 460 between the user's fingers and placing a clasp hole over post 456 and releasing. The headset is thereby secured to the user's clothing for transport while not in use and maintains easy accessibility when use is desired.

Referring to FIG. 15, an embodiment of a headset clip system 500 of the present invention in a decoupled state is illustrated. The headset clip system 500 includes a clip assembly 550 and a headset 502 having a headset interface 504. The clip assembly 550 includes an alligator clip 554 having a biting pair of spring loaded teeth, and a clip interface 552. The structure and operation of alligator clip 554 to clamp to the wearer's clothing is as described previously herein. In further examples, clip assembly 550 may utilize other devices capable of attaching to the wearer's clothing in place of alligator clip 554.

Headset interface 504 is a micro USB AB type receptacle (female) connector (also referred to as micro-AB), having a flat and narrow shape capable of receiving either a micro A or micro B connector plug. Clip interface 552 is a micro A or micro B connector plug. The plugs and sockets have 5 contacts, where the Mini-A plug has contacts 4 and 5 joined together inside the Mini-A plug. Both the Mini-A plug and Mini-B plug are rectangular in shape, with the contact opening measuring approximately 6.8(W)×3.1(H) mm.

In further examples, headset interface 504 and clip interface 552 may take the form of other types of USB connectors other than micro-type. For example, headset interface 504 may utilize mini-USB connectors. Headset interface 504 may also be an A-type or B-type connector as defined by the USB On-The-Go specification supplement to the USB 2.0 specification. The A-type USB interface has a flat and wide shape, while the B-type USB interface has a rectangular shape. Furthermore, headset interface 504 may take the form of a plug (male) or receptacle (female) USB connector, regardless of the USB architecture. In further examples, the headset interface 504 and clip interface 552 may utilize matching Ethernet or Firewire connectors.

When coupled, clip interface 552 has been inserted into headset interface 504. In this coupled state, clip assembly 550 is used to attach headset 502 to a user's clothing with the spring loaded teeth. The headset interface 504 has a dual use both as a charging interface to receive charging power for the headset battery and as an interface to attach a clip assembly 550. Headset interface 504 may also serve as a data interface to receive data transferred to or from headset 502. When integrated with a headset, the front surface of the headset interface 504 is exposed on the headset surface as shown in FIG. 15.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: form factor of the headset, and location of the headset interface. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1 A headset clip system comprising:
a clip assembly comprising;
a clip capable of gripping a cloth material;
a cylindrical plug comprising an interior receptacle and an exterior comprising a groove;
a headset interface comprising:
a housing with a front surface, wherein the front surface includes an aperture leading to a housing well;
a spring coil disposed within the housing well for positioning against the groove; and
a pin disposed within the housing well for inserting into the interior receptacle,
wherein the clip assembly is in a coupled state with the headset interface when the pin is inserted in the interior receptacle and the spring coil is in physical contact with the groove.

2. The headset clip system of claim 1, wherein the spring coil and pin comprise an electrically conductive material.

3. The headset clip system of claim 1, wherein the cylindrical plug comprises a non-electrically conductive material.

4. The headset clip system of claim 1, wherein the clip capable of gripping a cloth material comprises a pair of clipping portions and a spring.

5. The headset clip system of claim 1, wherein the spring coil and the pin form a first charging contact interface system, and wherein the headset interface further comprises a second charging contact interface system comprising conductive contacts disposed on the front surface outside the aperture.

6. The headset clip system of claim 1, wherein the headset interface is mounted from inside the housing and presents an approximately 6.5 mm diameter face.

7. A headset clip system comprising:
a clip assembly comprising;
a cylindrical plug comprising a first end, a second end, and an exterior comprising a groove, wherein the first end includes an interior receptacle;
a post portion with a third end attached to the second end and a fourth end having a pointed portion capable of piercing a cloth material; and
a clasp for receiving the pointed portion and releasably attaching to the post portion; and
a headset interface comprising:
a housing with a front surface, wherein the front surface includes an aperture leading to a housing well;
a spring coil disposed within the housing well for positioning against the groove; and
a pin disposed within the housing well for inserting into the interior receptacle,
wherein the clip assembly is in a coupled state with the headset interface when the pin is inserted in the interior receptacle and the spring coil is in physical contact with the groove.

8. The headset clip system of claim 7, wherein the clasp is a butterfly clutch.

9. The headset clip system of claim 7, wherein the spring coil and pin comprise an electrically conductive material.

10. The headset clip system of claim 7, wherein the cylindrical plug comprises a non-electrically conductive material.

11. The headset clip system of claim 7, wherein the spring coil and the pin form a first charging contact interface system, and wherein the headset interface further comprises a second charging contact interface system comprising conductive contacts disposed on the front surface outside the aperture.

12. The headset clip system of claim 7, wherein the headset interface is mounted from inside the housing and presents an approximately 6.5 mm diameter face.

13. A headset clip system comprising:
a headset comprising a headset interface utilizing a first coupling mechanism; and
a clip assembly comprising;
a clip device capable of gripping a cloth material; and
a second coupling mechanism capable of removably coupling to the first coupling mechanism.

14. The headset clip system of claim 13, wherein the first coupling mechanism is a charging interface capable of receiving charging power when coupled to a power source.

15. The headset clip system of claim 13, wherein the first coupling mechanism comprises a micro USB AB type receptacle connector and the second coupling mechanism comprises a micro A or micro B connector plug.

16. The headset clip system of claim 13, wherein the first coupling mechanism comprises a first magnet and the second coupling mechanism comprises a second magnet.

17. The headset clip system of claim 13, wherein the first coupling mechanism comprises a magnetic metal and the second coupling mechanism comprises a magnet, or the second coupling mechanism comprises a magnetic metal and the first coupling mechanism comprises a magnet.

18. The headset clip system of claim 13, wherein the clip device comprises a pair of clipping portions and a spring.

19. The headset clip system of claim 13, wherein the clip device comprises a clasp removably attachable to a post.

20. A headset clip assembly comprising:
a clip device capable of gripping a cloth material; and
a coupling mechanism capable of removably coupling to a headset interface, wherein the coupling mechanism is attached to the clip device.

21. The headset clip assembly of claim 20, wherein the headset interface is a charging interface capable of receiving charging power when coupled to a power source.

22. The headset clip assembly of claim 20, wherein the coupling mechanism comprises a micro A or micro B connector plug.

23. The headset clip assembly of claim 20, wherein the coupling mechanism comprises a magnet.

24. The headset clip assembly of claim 20, wherein the clip device comprises a pair of clipping portions and a spring.

25. The headset clip assembly of claim 20, wherein the clip device comprises a clasp removably attachable to a post.

26. A headset clip assembly comprising:
an affixing means for attaching to a cloth material; and
a coupling means for removably coupling to a headset interface, wherein the coupling means is attached to the affixing means.
